(19) United States
(12) Patent Application Publication
(10) Pub. No.: US 2013/0115577 A1
(43) Pub. Date: May 9, 2013

(54) METHOD AND APPARATUS TO TEACH BICYCLE RIDING

(71) Applicant: Lionnell Donnell, Victorville, CA (US)

(72) Inventor: Lionnell Donnell, Victorville, CA (US)

(21) Appl. No.: 13/291,325

(22) Filed: Nov. 8, 2011

(51) Int. Cl. G09B 9/04

(52) U.S. Cl. 434/61

(57) ABSTRACT

A bicycle training aid may teach children and toddlers how to ride a bike with light assistance from a trainer. With conventional bicycle training methods, a user must hold onto the bicycle to help balance the rider, which may be tiring or may cause back pain. With the bicycle trainer of the present invention, the trainer may hold onto a handle that is readily attached to the bicycle. The handle may be used to balance the bicycle while the rider learns to provide their own balance and control of the bicycle. The bicycle trainer may be easily removed from the bicycle for convenient storage and transport.

### BACKGROUND OF THE INVENTION

The present invention relates to bicycle training aids and, more particularly, to a device that can teach toddlers and children how to ride a bicycle with light assistance from a trainer.

Conventional bicycle assistance devices include training wheels that may minimize the possibility of a bicycle from tipping over. Children using training wheels may become dependent upon the training wheels and may not gain the confidence and balance needed to navigate a two-wheeled bicycle. Often a trainer, such as a parent or sibling, for example, may hold onto the bicycle when the rider is learning to ride on two wheels. Often, the only place to hold onto is the seat of the bicycle. This may be uncomfortable for the trainer. Moreover, by holding onto the seat, it may be difficult to fully control the bicycle from tipping from side to side.

As can be seen, there is a need for a bicycle riding training aid that can teach a rider to have the confidence and balance to navigate the bicycle without requiring the trainer to bend over to hold onto the bicycle or bicycle seat.

### SUMMARY OF THE INVENTION

In one aspect of the present invention, a bicycle trainer comprises a handle disposed on one end of the bicycle trainer; and a plurality of connection pieces adapted to attach to a bicycle, the plurality of connection pieces including at least one lower connection piece and an upper connection piece.

In another aspect of the present invention, a bicycle trainer comprises a handle disposed on one end of the bicycle trainer; first and second lower connection pieces adapted to attached to opposite sides of a rear wheel stud of a bicycle; and an upper connection piece having a connector to connect to a rear wheel fork of the bicycle.

These and other features, aspects and advantages of the present invention will become better understood with reference to the following drawings, description and claims.

### BRIEF DESCRIPTION OF THE DRAWINGS

FIG. 1 is a perspective view of a bicycle trainer according to an exemplary embodiment of the present invention;

FIG. 2 is a front view of the bicycle trainer of FIG. 1;

FIG. 3 is a side view of the bicycle trainer of FIG. 1;

FIG. 4 is an exploded view of the bicycle trainer of FIG. 1;

FIG. 5 is a close-up view of a pivot mechanism of the bicycle trainer of FIG. 1;

FIG. 6 is a close-up view of an adjustable connection for the bicycle trainer of FIG. 1;

FIG. 7 is a perspective view of the bicycle trainer of FIG. 1 in use on a bicycle;

FIG. 8 is an exploded perspective view of the bicycle trainer of FIG. 7 showing the assembly of the bicycle trainer on a bicycle; and

FIG. 9 is a perspective view showing convenient storage and carrying method for the bicycle trainer of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a bicycle training aid that may teach children and toddlers how to ride a bike with light assistance from a trainer. With conventional bicycle training methods, a user must hold onto the bicycle to help balance the rider, which may be tiring or may cause back pain. With the bicycle trainer of the present invention, the trainer may hold onto a handle that is readily attached to the bicycle. The handle may be used to balance the bicycle while the rider learns to provide their own balance and control of the bicycle. The bicycle trainer may be easily removed from the bicycle for convenient storage and transportation.

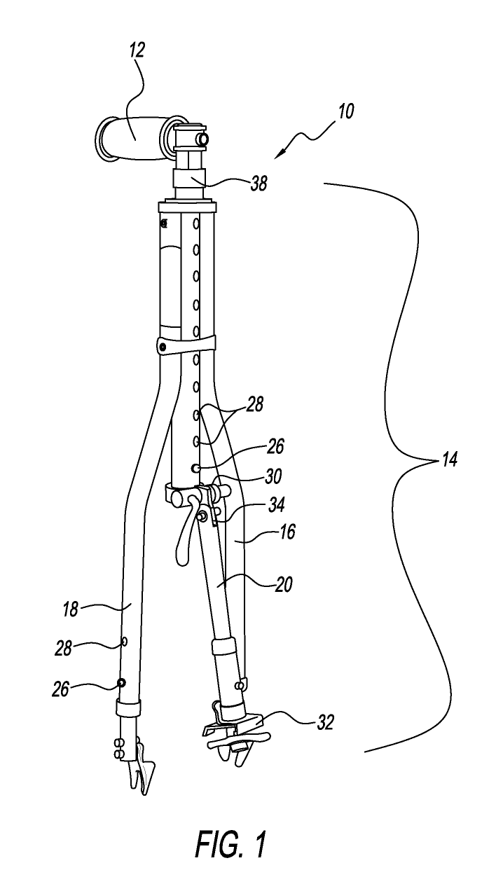

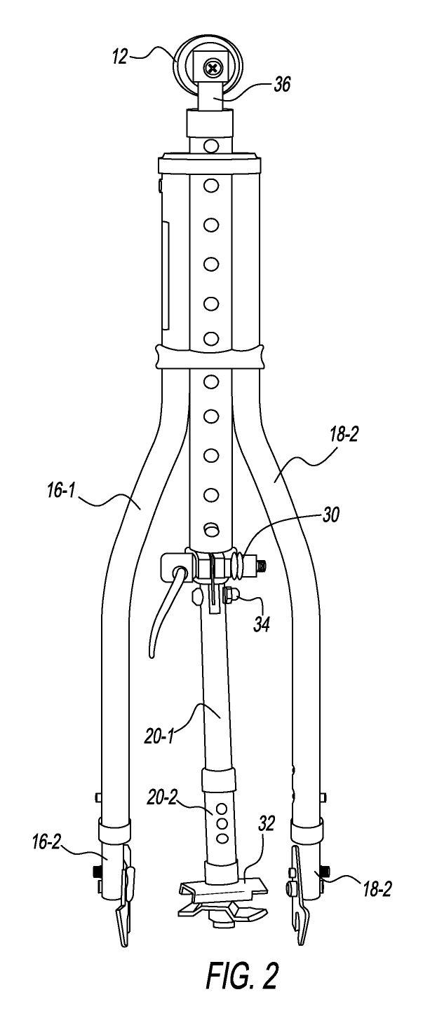

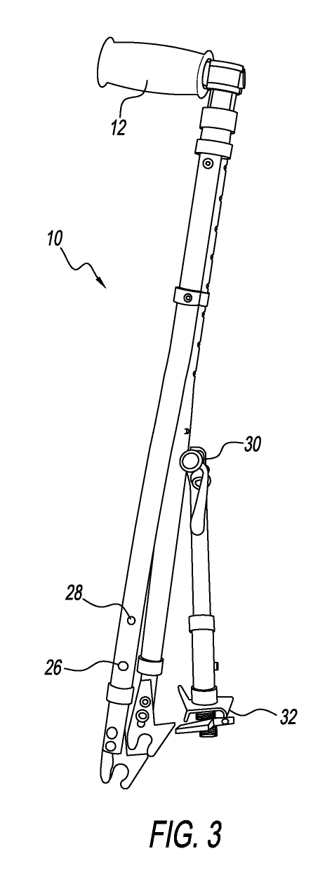

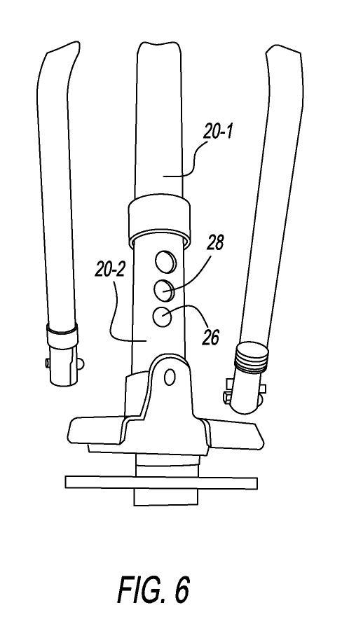

Referring now to FIGS. 1 through 9, a bicycle training aid 10 (also referred to as a bicycle trainer 10) may include a handle 12 attached to a plurality of bicycle connection pieces, referred collectively as connection pieces 14. The connection pieces 14 may include first and second lower connection pieces 16, 18 (also referred to as wheel connection pieces) and upper connection piece 20 (also referred to as stabilizer bar 20). The first and second lower connection pieces 16, 18 may attach, for example, to opposite sides of a rear wheel stud 22. The stabilizer bar 20 may attach to the bicycle between rear wheel forks 24.

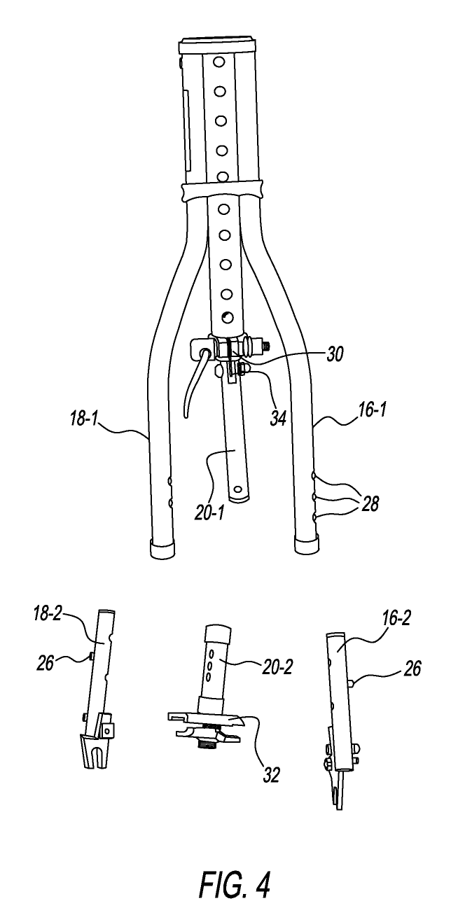

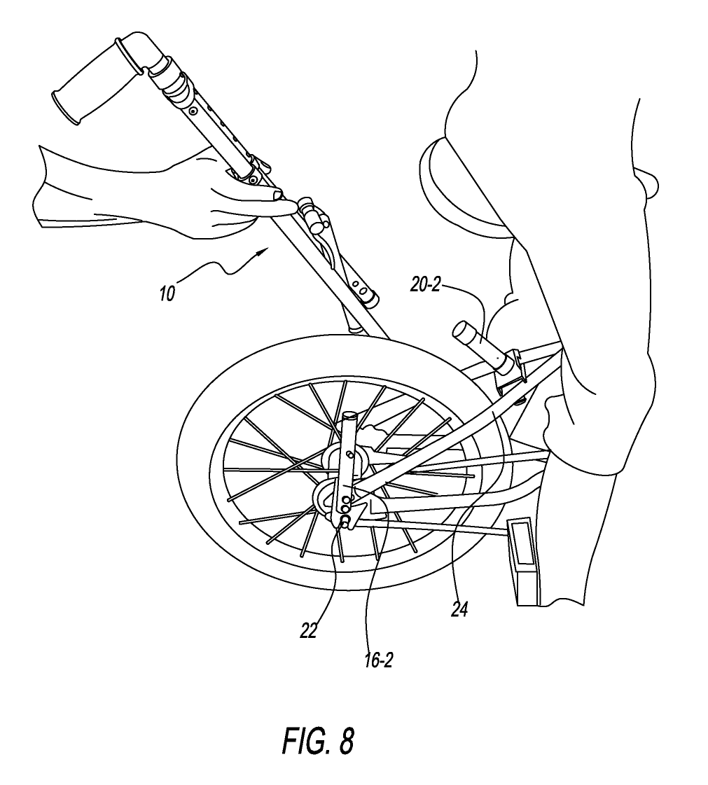

The first and second lower connection pieces 16, 18 may include upper first and second wheel connection pieces 16-1, 18-1 and lower first and second wheel connection pieces 16-2, 18-2. Similarly, the stabilizer bar 20 may include upper stabilizer bar 20-2 and lower stabilizer bar 20-2, as shown in greater detail in FIGS. 4 and 8. In some embodiments, the lower first and second connection pieces 16-2, 18-2 may be affixed to the bicycle. Similarly, the lower stabilizer bar 20-2 may also be affixed to the bicycle. The upper first and second connection pieces 16-1, 18-1 may adjustably connect to the lower first and second connection pieces 16-2, 18-2. Similarly, the upper stabilizer bar 20-1 may adjustably connect to the stabilizer bar 20-2. In some embodiments, these adjustable connection may result from the pieces (for example, 16-1 and 16-2, or 20-1 and 20-2) may be made from tubular material where one piece may slidably fit inside its corresponding piece. For example, lower first connection piece 16-1 may fit inside upper first connection piece 16-2. One of the first connection pieces 16-1, 16-2 may include a pin 26 and the other of the first connection pieces 16-1, 16-2 may include holes 28 along a portion of the length of the piece. The pin 26 may fit into one of the holes 28, to allow adjustment of the overall length of the piece 16. Similar adjustment mechanisms may be provided for the other pieces 18, 20. In some embodiments, the pin 26 and holes 28 may be only one pin 26 and one hole 28, which may not provide height adjustment but may provide a means for disconnecting the handle 12 from the lower connection pieces 16-2, 18-2, 20-2.

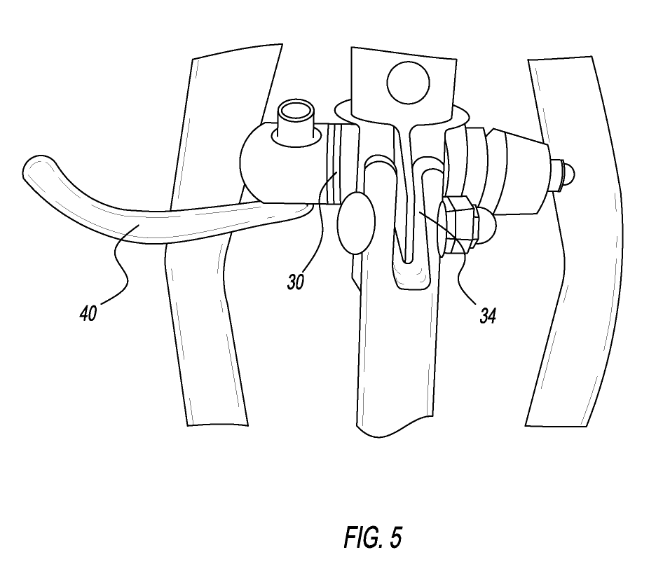

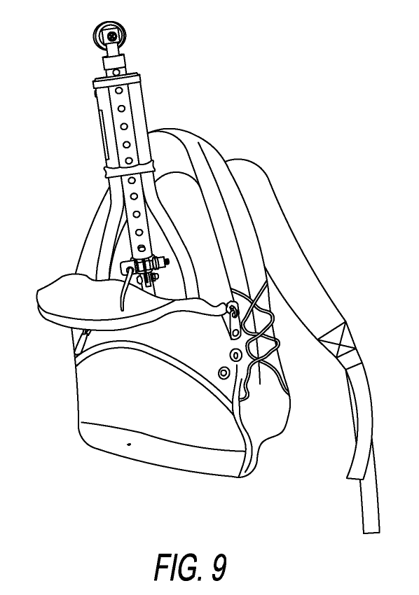

The upper stabilizer bar 20-1 may further include a length adjustment mechanism 30. This length adjustment mechanism 30 may be similar to those known in the art and may include pins and holes. In some embodiments, the length adjustment mechanism 30 may include tubes that fit inside each other. A clamping member may have an arm 40 (see FIG. 5) that may be turned to provide a clamping force between the two concentric tubular members to retain them at the desired length. The upper-upper connection piece 20-1 may further include a pivot mechanism 34. The pivot mechanism 34 may permit the upper stabilizer bar 20-1 to pivot relative to the fixed upper first and second connection pieces 16-1, 18-2. The length adjustment mechanism 30 and the pivot mechanism 34 may permit the bicycle trainer 10 to be attached to a variety of bicycle configuration and sizes. Furthermore, the pivot mechanism 34 may permit the bicycle trainer 10 to fold to a flat configuration for easy transport and storage, as shown in FIG. 9.

As discussed above, the lower stabilizer bar 20-2 may attach between rear wheel forks 24. A connection feature 32 may be provided to attach the lower stabilizer bar 20-2 to the forks 24. In some embodiments, this connection feature 32 may include a first plate and a second plate that sandwiches the rear wheel forks 24. In some embodiments, the connection feature 32 may attach to a connection, such as a bar or a hole in a connection bar (not shown) that is already present on the bicycle.

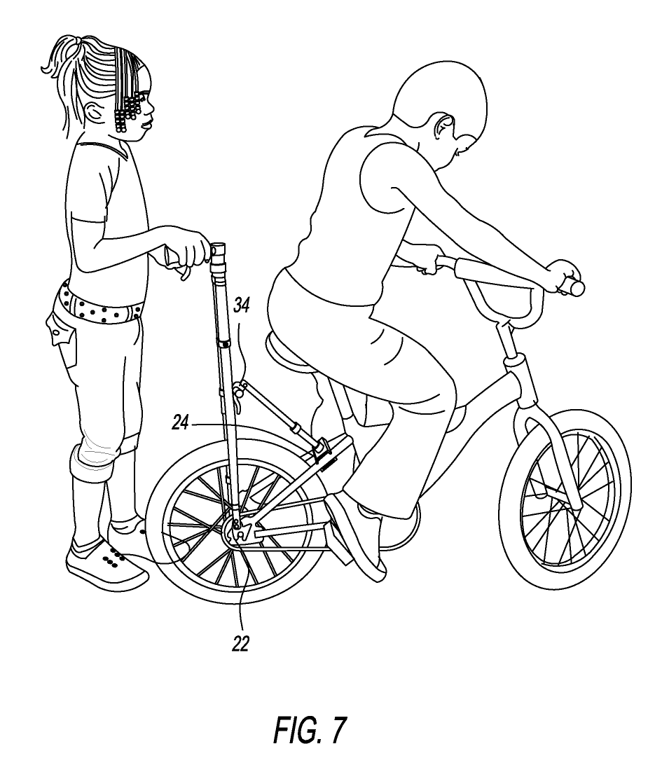

The handle 12 may extend from the connection pieces 14, typically from the upper stabilizer bar 20-1. The handle 12 may be attached to an extension tube 36 that may fit into the stabilizer bar 20. The extension tube 36 may be raised from or lowered into the connection piece 20 to adjust the height of the handle 12 relative to the bicycle. FIG. 7 shows a child helping another child learn to ride a bicycle. However, because the height of the handle 12 is adjustable, an adult may also comfortably use the bicycle trainer 10. A twist clamp 38 may be provided to fix the extension tube 36 at a desired extension.

To use the bicycle trainer 10, a user may first affix the lower first and second connection pieces 16-2, 18-2 to the bicycle rear wheel studs 22. The user may then affix the lower stabilizer bar 20-2 to the bicycle rear wheel fork 24. Then, the remainder of the bicycle trainer 10 may be removable attached to the connection pieces 16-2, 18-2 and 20-2. The length and angle of the stabilizer bar 20 may be adjusted with the length adjustment mechanism 30 and the pivot mechanism 34. The height of the handle 12 may then be adjusted to a confortable height for the user. A rider may get on the bicycle and the trainer/user may help balance the rider as they ride, as shown in FIG. 7. The amount of force used on the handle 12 by the user/trainer can be lessened as the rider gains confidence and balance. The bicycle trainer 10 may remain attached to the bicycle while the user learns to ride on their own. This may help develop the rider's confidence, as they may not be aware when the helper releases the trainer 10. Once the bicycle trainer 10 is no longer needed, it may be initially only disconnected from the affixed lower connection pieces 16-2, 18-2 and 20-2, which can remain affixed to the bicycle. If additional training is needed, the bicycle trainer 10 may be easily reconnected to the bicycle.

While the above description refers to the bicycle trainer 10 as a device for teaching children how to ride a bicycle, the device may also be used for exercising. For example, a child may ride the bicycle while the trainer may jog, power walk, or walk behind the bicycle, getting exercise while the rider steers the bicycle.

It should be understood, of course, that the foregoing relates to exemplary embodiments of the invention and that modifications may be made without departing from the spirit and scope of the invention as set forth in the following claims.

What is claimed is:

1. A bicycle trainer comprising:
a handle disposed on one end of the bicycle trainer;
a plurality of connection pieces adapted to attach to a bicycle, the plurality of connection pieces including at least one wheel connection piece and a stabilizer bar connection piece.

2. The bicycle trainer of claim 1, wherein the at least one wheel connection piece includes first and second wheel connection pieces adapted to attached to opposite sides of a rear wheel stud.

3. The bicycle trainer of claim 2, wherein the stabilizer bar connection piece includes a connector to connect to a rear wheel fork of the bicycle.

4. The bicycle trainer of claim 3, wherein the first and second wheel connection pieces includes upper first and second wheel connection pieces and lower first and second wheel connection pieces, the lower first and second wheel connection pieces adapted to be affixed to the bicycle and the upper first and second wheel connection pieces adapted to be removably attached to the lower first and second wheel connection pieces.

5. The bicycle trainer of claim 4, wherein the stabilizer bar connection piece includes an upper stabilizer bar and a lower stabilizer bar, the lower stabilizer bar adapted to be affixed to the bicycle and the upper stabilizer bar adapted to be removably attached to the lower stabilizer bar.

6. The bicycle trainer of claim 5, further comprising a length adjustment mechanism on the upper stabilizer bar, the length adjustment mechanism adapted to change the length of the upper stabilizer bar.

7. The bicycle trainer of claim 6, further comprising a pivot mechanism on the upper stabilizer bar, the pivot mechanism adapted to permit the upper stabilizer bar to pivot relative to the upper first and second wheel connection pieces.

8. The bicycle trainer of claim 1, wherein the handle is attached to an extension tube, the extension tube adapted to fit inside of the stabilizer bar connection piece to adjust a height of the handle relative to the bicycle.

9. A bicycle trainer comprising:
a handle disposed on one end of the bicycle trainer;
first and second wheel connection pieces adapted to attached to opposite sides of a rear wheel stud of a bicycle; and
a stabilizer bar connection piece having a connector to connect to a rear wheel fork of the bicycle.

10. The bicycle trainer of claim 9, wherein the first and second wheel connection pieces includes upper first and second wheel connection pieces and lower first and second wheel connection pieces, the lower first and second wheel connection pieces adapted to be affixed to the bicycle and the upper first and second wheel connection pieces adapted to be removably attached to the lower first and second wheel connection pieces.

11. The bicycle trainer of claim 10, wherein the stabilizer bar connection piece includes an upper stabilizer bar and a lower stabilizer bar, the lower stabilizer bar adapted to be affixed to the bicycle and the upper stabilizer bar adapted to be removably attached to the lower stabilizer bar.

12. The bicycle trainer of claim 11, further comprising a length adjustment mechanism on the upper stabilizer bar, the length adjustment mechanism adapted to change the length of the upper stabilizer bar.

13. The bicycle trainer of claim 12, further comprising a pivot mechanism on the upper stabilizer bar, the pivot mechanism adapted to permit the upper stabilizer bar to pivot relative to the upper first and second wheel connection pieces.

14. The bicycle trainer of claim 9, wherein the handle is attached to an extension tube, the extension tube adapted to fit inside of the stabilizer bar connection piece to adjust a height of the handle relative to the bicycle.
